(19) United States
(12) Patent Application Publication
(10) Pub. No.: US 2026/0329088 A1
(43) Pub. Date: Oct. 22, 2026

(54) NEAR-EYE DISPLAY DEVICE

(71) Applicants: Interface Advanced Technology (Chengdu) Co., Ltd., Chengdu (CN); Interface Technology (ChengDu) Co., Ltd., Chengdu (CN); INTERFACE OPTOELECTRONICS (SHENZHEN) CO., LTD., Shenzhen (CN); GENERAL INTERFACE SOLUTION LIMITED, Zhunan (TW)

(72) Inventors: PO-LUN CHEN, Zhunan (TW); YUN-PEI CHEN, Zhunan (TW); TING-HUI CHEN, New Taipei (TW)

(21) Appl. No.: 19/468,047

(22) Filed: Feb. 3, 2026

Related U.S. Application Data
(63) Continuation-in-part of application No. PCT/CN2025/086147, filed on Mar. 31, 2025.

(51) Int. Cl. G02B 27/01; G02B 3/14; G02B 27/42

(52) U.S. Cl. CPC G02B 27/0172; G02B 3/14; G02B 27/4205; G02B 2027/014; G02B 2027/0154; G02B 2027/0163; G02B 2027/0178; G02B 2027/0194

(57) ABSTRACT

Embodiments of the present disclosure provide a near-eye display device. The near-eye display device includes a display module for emitting image light, a waveguide for conducting the image light, an out-coupling grating for coupling out the image light from the waveguide, a first variable focus module on optical paths of the image light and ambient light, and a control module. The first variable focus module includes a plurality of focus units. The control module is electrically connected to each focus unit and configured to independently change a diopter of each focus unit, so that each focus unit independently adjusts focus positions of the ambient light and the image light.

### FIELD

The subject matter herein generally relates to the field of near-eye display, specifically a near-eye display device.

### BACKGROUND

Near-eye display systems include Augmented Reality (AR) display systems, Virtual Reality (VR) display systems, Mixed Reality (MR) display systems, or Extended Reality (XR) systems. AR display systems superimpose and fuse virtual scenes or information with the real environment, presenting them interactively to users, thereby creating an environment where virtual and real elements share the same space.

However, for users with refractive issues, such as myopia, hyperopia, and astigmatism, when viewing the same scene, they need to constantly adjust their eyes focus to different positions to clearly see both virtual scenes and the real environment, such as distant or near objects, which easily causes eye fatigue and results in poor user experience.

Therefore, there is room for improvement in the art.

### BRIEF DESCRIPTION OF THE DRAWINGS

Implementations of the present disclosure will now be described, by way of embodiment, with reference to the attached figures.

FIG. 1 is a schematic structural diagram of a near-eye display device according to an embodiment of the present disclosure.

FIG. 2 is a schematic diagram of an optical system and a control module according to an embodiment of the present disclosure.

FIG. 3 is a schematic plan view of the optical system in FIG. 2.

FIG. 4 is a schematic diagram of a human eye focused after correction by the near-eye display device of the embodiment of the present disclosure.

FIG. 5 is a schematic diagram of an optical system and a control module according to another embodiment of the present disclosure.

FIG. 6 is a schematic diagram of an optical system including a first variable focus module and a control module according to another embodiment of the present disclosure.

FIG. 7 is a top view of the first variable focus module shown in FIG. 6, including a plurality of focus units.

FIG. 8 is a schematic diagram when the control module in FIG. 6 changes curvatures of sub-light-transmitting surfaces of the plurality of focus units.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. The term “circuit” is defined as an integrated circuit (IC) with a plurality of electric elements, such as capacitors, resistors, amplifiers, and the like.

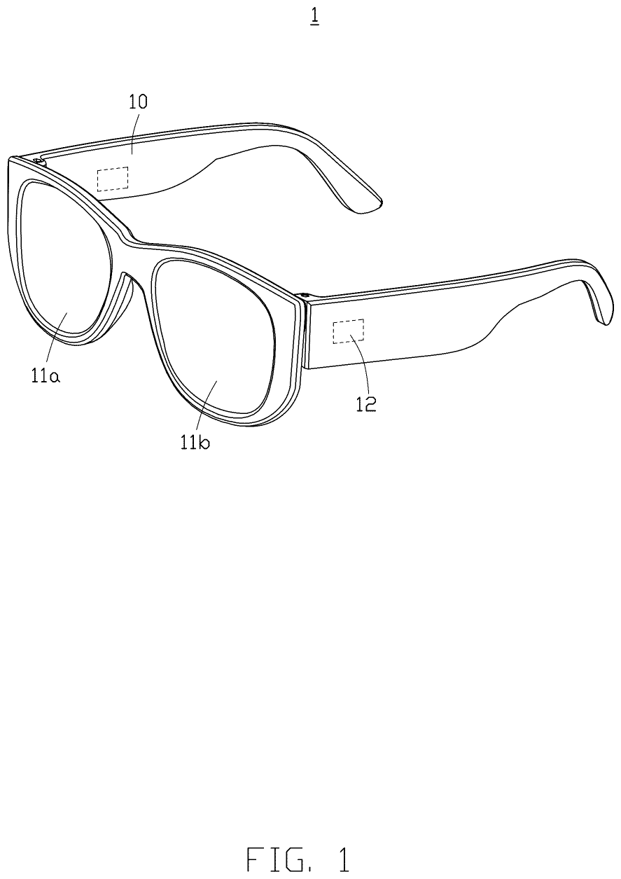

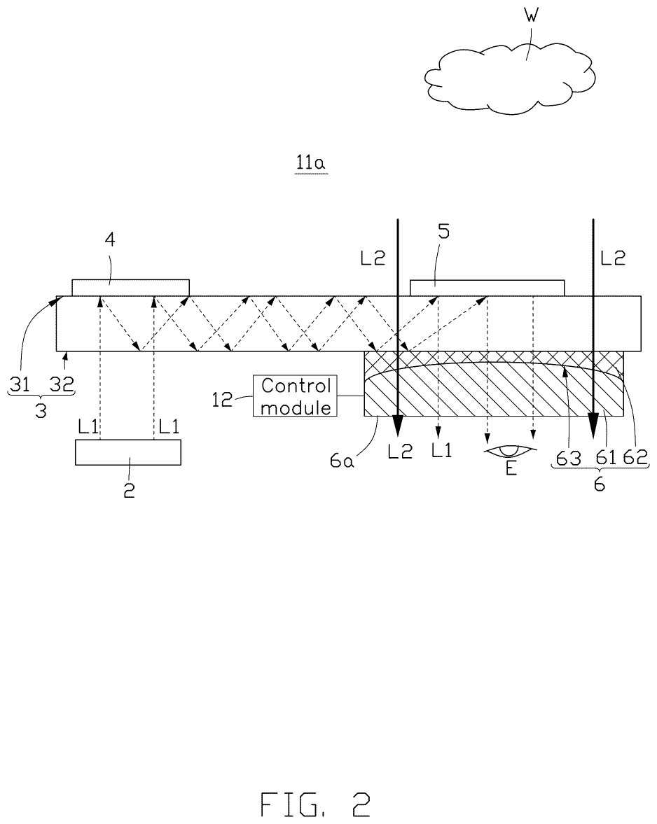

As shown in FIG. 1 and FIG. 2, a near-eye display device 1 according to an embodiment of the present disclosure includes a frame 10, a first optical system 11a on the frame 10, a second optical system 11b on the frame 10, and a control module 12. The structures and functions of the first optical system 11a and the second optical system 11b are substantially the same. The first optical system 11a is arranged on a left side of the frame 10 for imaging to the user's left eye; the second optical system 11b is arranged on a right side of the frame 10 for imaging to the user's right eye.

The control module 12 is arranged on the frame 10 (for example, on a temple on either side of the frame 10). The control module 12 is configured to control the display content of the first optical system 11a and the second optical system 11b. The control module 12 includes a power supply (not shown) and a controller (not shown). The power supply is configured to apply voltage to the first optical system 11a, the second optical system 11b and the controller. The controller is configured to control a magnitude of voltage applied to the first optical systems 11a and the second optical system 11b. The controller may be any one of a controller including an RS485 interface, a Central Processing Unit (CPU), and a microcontroller, such as an STM32 microcontroller, 51 microcontroller, TMS microcontroller, PIC microcontroller, or AVR microcontroller, which is not limited thereto.

The near-eye display device 1 according to the embodiment of the present disclosure is an AR display device. When the user wears the AR display device, the user's eyes can observe the projected image displayed by the first optical systems 11a and the second optical system 11b, while ambient light L2 reflected by an environmental object W in the real environment can also enter the human eyes E through the near-eye display device 1, enabling the human eyes E to also observe images of the real world, thereby allowing the human eyes E to observe the projected images superimposed on the real-world images.

In other embodiments, the near-eye display device 1 can be an MR display device or an XR display device, which is not limited thereto.

The structure and function of the first optical system 11a are described below as an example.

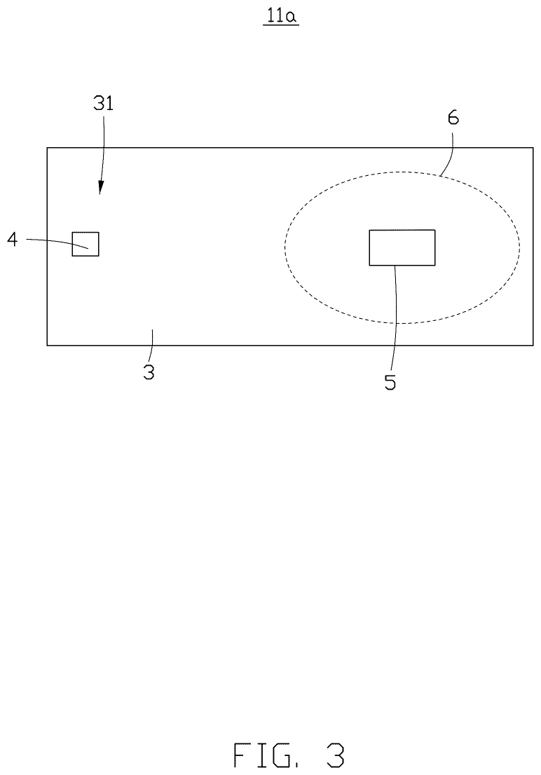

Referring to FIG. 1, FIG. 2, and FIG. 3 together, the optical system 11a includes a display module 2, a waveguide 3, an in-coupling grating 4, an out-coupling grating 5, and a first variable focus module 6. The display module 2 is disposed at a position where the temple of the frame 10 connects to the lens, and is configured to emit image light L1.

The display module 2 can be any one of a Micro Light-emitting Diode (Micro LED) display, a Mini Light-emitting Diode (Mini LED) display, and an Organic Light-emitting Diode (OLED) display, which is not limited thereto.

The waveguide 3 is embedded in the frame 10 and is configured to guide the image light L1. The waveguide 3 has an overall substantially rectangular plate-like structure, and includes a first surface 31 and a second surface 32 opposite to the first surface 31. The first surface 31 and the second surface 32 have substantially rectangular outer contours. A material of the waveguide 3 can be, but not limited to, transparent glass or transparent plastic, such as polyethylene glycol terephthalate (PET), polycarbonate (PC), and polymeric methyl methacrylate (PMMA).

The in-coupling grating 4 and the out-coupling grating 5 are spaced apart from each other on the first surface 31. The in-coupling grating 4 is configured to couple the image light L1 into the waveguide 3. The out-coupling grating 5 is configured to receive and couple out the image light L1 emitted from the waveguide 3. Each of the in-coupling grating 4 and the out-coupling grating 5 can be a surface relief grating, a volume holographic grating, or a polarization volume holographic grating, which is not limited thereto.

The first variable focus module 6 is on the second surface 32 and is on the optical paths of the image light L1 and the ambient light L2. The orthogonal projection of the first variable focus module 6 on the waveguide 3 has a substantially rectangular outer contour and covers the orthogonal projection of the out-coupling grating 5 on the waveguide 3. The first variable focus module 6 is configured to receive the image light L1 and the ambient light L2, and transmit the image light L1 and the ambient light L2 to the human eyes E.

When the user wears the near-eye display device 1, part of the ambient light L2 reflected by the environmental object W sequentially passes through the waveguide 3 and the first variable focus module 6 and then enters the eye box range. Another part of the ambient light L2 reflected by the environmental object W sequentially passes through the out-coupling grating 5, the waveguide 3, and the first variable focus module 6 and then enters the eye box range. The image light L1 emitted by the display module 2 sequentially passes through the in-coupling grating 4, the waveguide 3, the out-coupling grating 5, and the first variable focus module 6 and then enters the eye box range. The image light L1 and the ambient light L2 are received together by the human eyes E, so that the human eyes E observe an AR image.

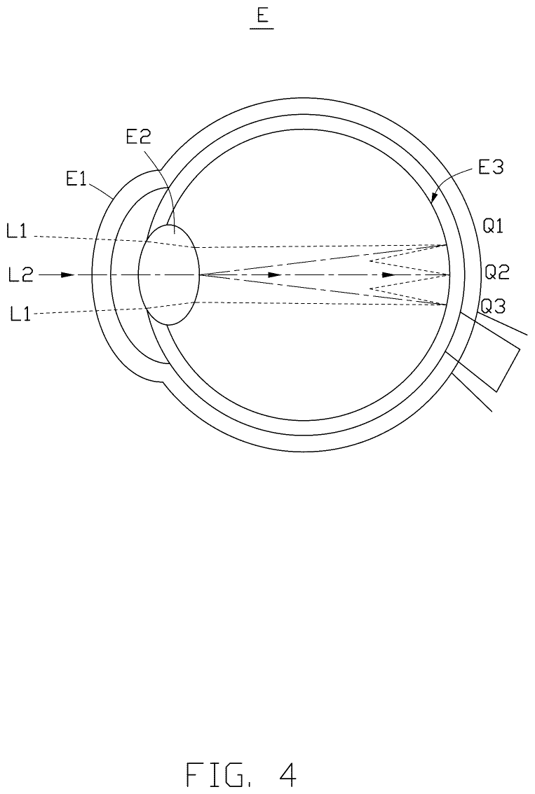

Referring to FIG. 2 and FIG. 4 together, for users with refractive issues, light cannot be precisely focused on the retina E3 after passing through the cornea E1 and the crystalline lens E2. For example, for hyperopic users, light is focused behind the retina E3 after passing through their cornea E1 and the crystalline lens E2, and cannot be focused exactly on the retina E3, resulting in the human eyes E being able to see distant objects but not nearby objects.

The control module 12 is further configured to change the diopter of the first variable focus module 6 to adjust the focus positions of the ambient light L2 and the image light L1. For example, the control module 12 can adjust the diopter of the first variable focus module 6 according to the degree of the user's hyperopia (or myopia) of the user, that is, adjust the focal length of the first variable focus module 6, so that the image light L1 coupled out from the out-coupling grating 5 is focused on the focal point Q2 on the retina E3, after sequentially passing through the user's cornea E1 and crystalline lens E2 following the first variable focus module 6.

Part of the ambient light L2 reflected by the environmental object W is focused on the focal point Q1 of the retina E3 after sequentially passes through the user's cornea E1 and crystalline lens E2 following the waveguide 3 and the first variable focus module 6, thereby enabling users with refractive issues to clearly see virtual scenes and different external scenes.

By providing the first variable focus module 6 and the control module 12, wherein the control module 12 is configured to change the diopter of the first variable focus module 6 to adjust the focus positions of the ambient light L2 and the image light L1, the diopter of the first variable focus module 6 can be changed according to the eyeglass prescription of users with refractive issues, such as myopia, hyperopia, and astigmatism users, so that both the image light L1 and the ambient light L2, after sequentially passing through the first variable focus module 6 and the crystalline lens E2 of the human eyes E, can be focused on the retina E3 of the user, thereby enabling users with refractive issues to clearly see both the real environment and the virtual scene formed by the image light L1 simultaneously.

That is, the control module 12 can change the diopter of the first variable focus module 6 to enable users with refractive issues to clearly see both virtual scenes and different external scenes, which helps reduce eyestrain for users with refractive issues, and thereby improves the user experience.

In some embodiments, the control module 12 is further configured to change the diopter of the first variable focus module 6 by changing at least one of spacing variation, polarization switching, refractive index gradation, pressure variation, voltage variation, or piezoelectric variation.

In some embodiments, the control module 12 is further configured to change the diopter of the first variable focus module 6 by spacing variation, the first variable focus module 6 includes a plurality of lenses (not shown) having refractive power stacked on the second surface 32, and the control module 12 is configured to change the relative positions of the plurality of lenses, thereby changing the overall effective focal length of the first variable focus module 6, that is, changing the diopter of the first variable focus module 6, so as to adjust the focus positions of the ambient light L2 and the image light L1.

In some embodiments, the control module 12 changes the diopter of the first variable focus module 6 by polarization switching, the first variable focus module 6 includes a liquid crystal lens (not shown) arranged on the second surface 32, and the control module 12 can change the diopter of the first variable focus module 6 by changing the polarization direction of the image light L1 and the ambient light L2.

In some embodiments, the control module 12 changes the diopter of the first variable focus module 6 by refractive index gradation, the first variable focus module 6 includes a light-transmitting liquid crystal cell (not shown) arranged on the second surface 32, and the control module 12 is electrically connected to the first variable focus module 6 and is configured to apply voltages of different magnitudes to the first variable focus module 6 to control the arrangement of liquid crystal molecules in the first variable focus module 6, thereby changing the refractive index of the first variable focus module 6, and further changing the diopter of the first variable focus module 6.

In some embodiments, the control module 12 changes the diopter of the first variable focus module 6 by pressure variation, the first variable focus module 6 includes a liquid lens (not shown) arranged on the second surface 32. The liquid lens includes a housing containing a liquid material, and the control module 12 is configured to control the volume of the liquid material in the housing, thereby controlling the overall radius of curvature of the liquid lens, and further controlling the diopter of the first variable focus module 6.

In some embodiments, the control module 12 changes the diopter of the first variable focus module 6 by piezoelectric variation, the first variable focus module 6 includes a piezoelectric lens (not shown) arranged on the second surface 32. The piezoelectric lens includes a piezoelectric material layer (not shown), and the control module 12 is electrically connected to the first variable focus module 6 and is configured to apply voltages of different magnitudes to the first variable focus module 6 to control the volume of the piezoelectric material layer in the first variable focus module 6, thereby changing the overall curvature of the piezoelectric lens, and further changing the diopter of the first variable focus module 6.

In some embodiments, the control module 12 changes the diopter of the first variable focus module 6 by voltage variation. The first variable focus module 6 includes a first housing 6a, a first medium 61 contained in the first housing 6a, a second medium 62 contained in the first housing 6a, and a first light-transmitting surface 63 between the first medium 61 and the second medium 62. Both the image light L1 and the ambient light L2 can pass through the first medium 61, the second medium 62, and the first light-transmitting surface 63.

The first medium 61 is arranged on a side of the second medium 62 away from the waveguide 3, and the second medium 62 is arranged between the waveguide 3 and the first medium 61. Both the first medium 61 and the second medium 62 are liquid and immiscible with each other, such that the first light-transmitting surface 63 is formed between the first medium 61 and the second medium 62. The first light-transmitting surface 63 protrudes toward the direction close to the waveguide 3.

The refractive index of the first medium 61 is different from that of the second medium 62. The refractive index of the second medium 62 is greater than the refractive index of the first medium 61.

In some embodiments, the second medium 62 is a conductive liquid (such as an organic salt solution), and the first medium 61 is a non-conductive solution (such as an organic polymer solution such as silicone oil). In some embodiments, the second medium 62 is a non-conductive liquid, and the first medium 61 is a conductive solution, which is not limited thereto.

The refractive index of the second medium 62 is set to be greater than the refractive index of the first medium 61, and the first light-transmitting surface 63 protrudes toward the waveguide 3, such that the shape of the second medium 62 with a larger refractive index is substantially concave lens-shaped, which can diverge light.

The control module 12 is electrically connected to the first variable focus module 6 and utilizes the principle of electrowetting effect to control the curvature of the first light-transmitting surface 63 of the first variable focus module 6 by applying an external voltage, thereby changing the diopter of the first variable focus module 6, and further adjusting the focus positions of the ambient light L2 and the image light L1.

For hyperopic users, light is focused behind the retina E3 after passing through the cornea E1 and the crystalline lens E2, and cannot be focused precisely on the retina E3. The control module 12 controls the curvature of the first light-transmitting surface 63 of the first variable focus module 6 by applying an external voltage, thereby changing the diopter of the first variable focus module 6 to match to the eyeglass prescription of hyperopic users, so that the virtual image point formed by the image light L1 moves from infinity toward the human eyes E, thereby enabling the image light L1 to be focused on the focal point Q2 on the retina E3 after passing through the first variable focus module 6, the cornea E1, and the crystalline lens E2, thereby enabling the human eyes E to clearly see the virtual image formed by the image light L1.

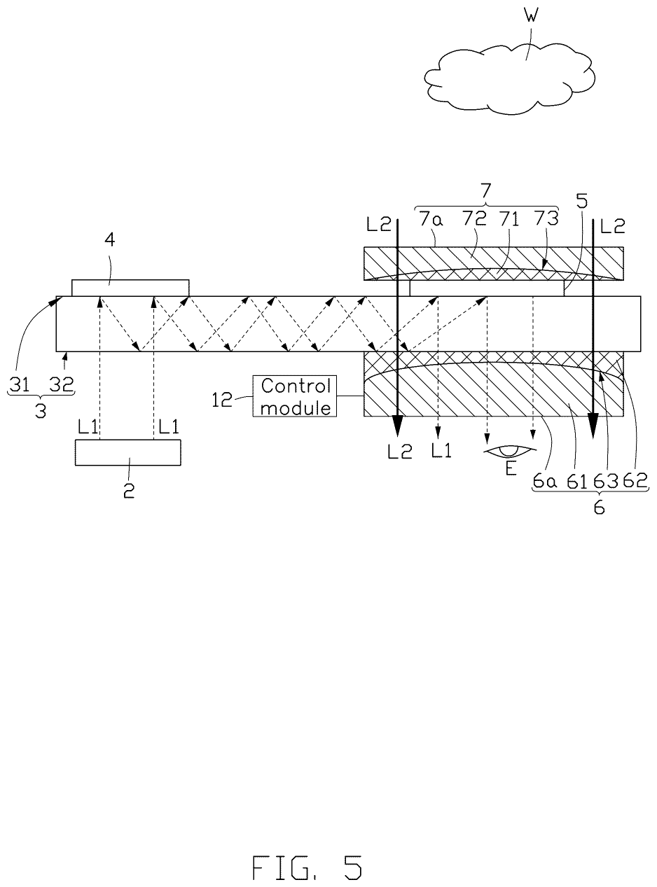

Referring to FIG. 4 and FIG. 5 together, the optical system 11a further includes a second variable focus module 7. The second variable focus module 7 is arranged on the first surface 31 and on the optical path of the ambient light L2. The second variable focus module 7 is configured to receive the ambient light L2 and transmit the ambient light L2 to the human eyes E. The orthogonal projection of the second variable focus module 7 on the waveguide 3 covers the orthogonal projection of the out-coupling grating 5 on the waveguide 3, and the size of the orthogonal projection of the second variable focus module 7 on the waveguide 3 is substantially equal to the size of the orthogonal projection of the first variable focus module 6 on the waveguide 3.

The control module 12 is further configured to change the diopter of the second variable focus module 7 to adjust the focus position of the ambient light L2. That is, the control module 12 can independently change the diopters of the first variable focus module 6 and the second variable focus module 7 to separately adjust the focus positions of the ambient light L2 and the image light L1.

The manner in which the control module 12 changes the diopter of the second variable focus module 7 by changing at least one of spacing variation, polarization switching, refractive index gradation, pressure variation, voltage variation, or piezoelectric variation. The manner in which the control module 12 changes the diopters of the second variable focus module 7 and the first variable focus module 6 may be the same or different, which is not limited thereto.

In one embodiment, the manner in which the control module 12 changes the diopter of the second variable focus module 7 by voltage variation. The second variable focus module 7 includes a second housing 7a, a third medium 71 contained in the second housing 7a, a fourth medium 72 contained in the second housing 7a, and a second light-transmitting surface 73 between the third medium 71 and the fourth medium 72. The ambient light L2 can pass through the third medium 71, the fourth medium 72, and the second light-transmitting surface 73.

The third medium 71 is arranged on a side of the fourth medium 72 close to the waveguide 3, and the third medium 71 is between the waveguide 3 and the fourth medium 72. Both the third medium 71 and the fourth medium 72 are liquid and immiscible with each other, such that the second light-transmitting surface 73 is formed between the third medium 71 and the fourth medium 72. The second light-transmitting surface 73 protrudes away from the waveguide 3. The refractive index of the third medium 71 is different from that of the fourth medium 72. The refractive index of the third medium 71 is greater than the refractive index of the fourth medium 72.

In some embodiments, the third medium 71 is a conductive liquid, and the fourth medium 72 is a non-conductive solution. In some embodiments, the third medium 71 is a non-conductive liquid, and the fourth medium 72 is a conductive solution, which is not limited thereto.

The refractive index of the third medium 71 is set to be greater than the refractive index of the fourth medium 72, and the second light-transmitting surface 73 protrudes away from the waveguide 3, such that the shape of the third medium 71 with a larger refractive index is substantially convex lens-shaped, which can converge the ambient light L2.

The control module 12 is electrically connected to the second variable focus module 7 and utilizes the principle of electrowetting effect to control the curvature of the second light-transmitting surface 73 of the second variable focus module 7 by applying an external voltage, thereby changing the diopter of the second variable focus module 7, and further adjusting the focus positions of the ambient light L2 and the image light L1.

For example, the control module 12 can adjust the diopter of the first variable focus module 6 according to the degree of hyperopia (or myopia) of the user, that is, adjust the focal length of the first variable focus module 6, so that the virtual image point formed by the image light L1 moves from infinity toward the human eyes E, and the image light L1 can be focused on the focal point Q2 on the retina E3 after passing through the first variable focus module 6, the cornea E1, and the crystalline lens E2, thereby enabling the human eyes E to clearly see the virtual image formed by the image light L1.

After the human eye E can clearly see the virtual image formed by the image light L1, the control module 12 then adjusts the diopter of the second variable focus module 7 according to the degree of hyperopia (or myopia) of the user, that is, adjusts the focal length of the second variable focus module 7, so that part of the ambient light L2 reflected by the environmental object W enters the human eyes E after passing through the second variable focus module 7, the waveguide 3, and the first variable focus module 6, and is then focused on the focal point Q1 of the retina E3 after sequentially passing through the user's cornea E1 and the crystalline lens E2, thereby enabling users with refractive issues to clearly see different external scenes, and further enabling users to clearly see both virtual scenes and different external scenes simultaneously.

Furthermore, when the user wants to clearly see distant (or nearby) objects, the diopter of the second variable focus module 7 can be further adjusted through the control module 12, so that the ambient light L2 is focused on the focal point Q3 of the retina E3 after passing through the user's cornea E1 and the crystalline lens E2, thereby enabling users with refractive issues to clearly see environmental objects W at different positions, which helps reduce eyestrain for users with refractive issues and thereby improves the user experience.

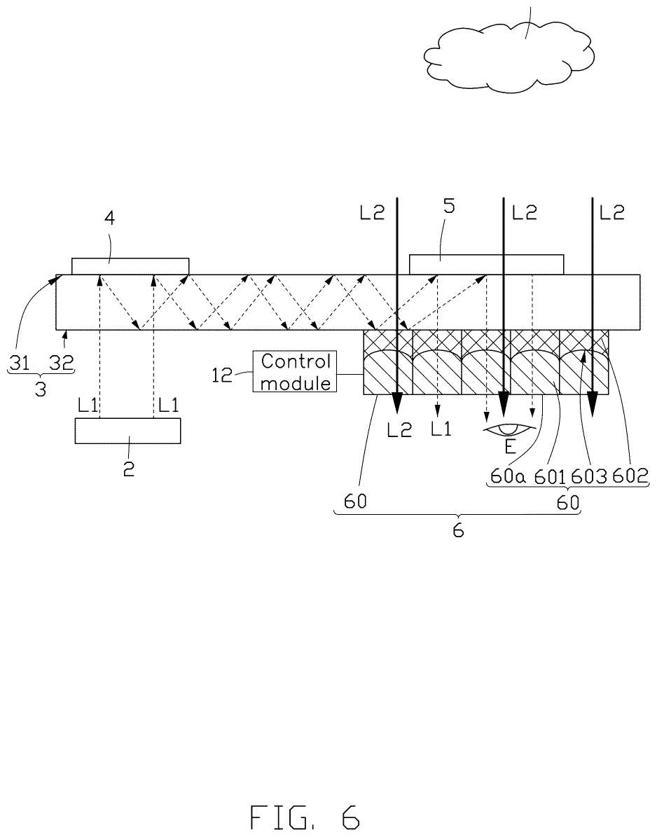

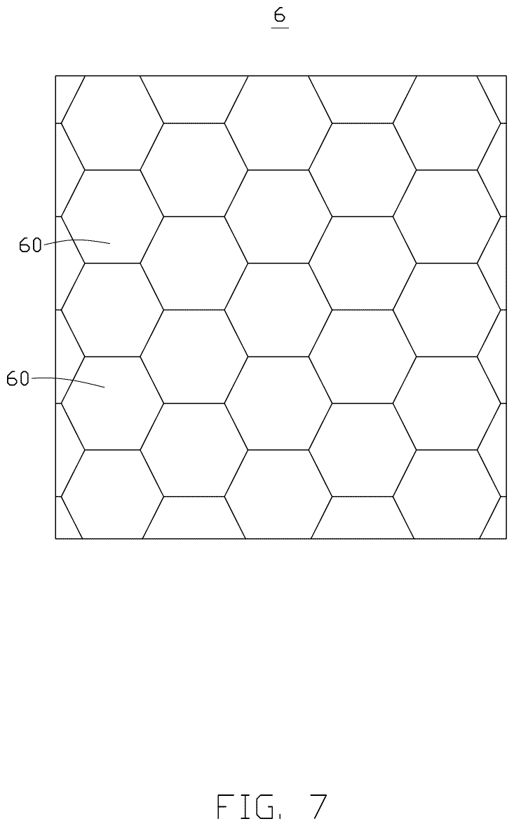

Referring to FIG. 4, FIG. 6, and FIG. 7 together, in one embodiment, the optical system 11a includes a display module 2, a waveguide 3, an in-coupling grating 4, an out-coupling grating 5, and a first variable focus module 6. The first variable focus module 6 includes a plurality of focus units 60. The focus units 60 are connected to each other and arranged in an array. The shape of the orthogonal projection of each focus unit 60 on the waveguide 3 is the same and is hexagonal.

In other embodiments, the shape of the orthogonal projection of each focus unit 60 on the waveguide 3 is selected from a group consisting of circular, triangular, or quadrilateral.

The orthogonal projection of the first variable focus module 6 on the waveguide 3 covers the orthogonal projection of the out-coupling grating 5 on the waveguide 3. at least one of the focus units 60 has an orthogonal projection on the waveguide 3 are within the orthogonal projection of the out-coupling grating 5 on the waveguide 3 and is configured to receive both the image light L1 and the ambient light L2, and at least one of the focus units 60 on the waveguide 3 are outside the orthogonal projection of the out-coupling grating 5 on the waveguide 3 and is configured to receive the ambient light L2 and exclude the image light L1.

That is, the focus units 60 include a first group of focus units overlapping with the out-coupling grating 5 in a plan view, and a second group of focus units non-overlapping with the out-coupling grating 5 in the plan view. Specifically, orthogonal projections of the first group of focus units on the waveguide 3 are within the orthogonal projection of the out-coupling grating 5 on the waveguide 3, and orthogonal projections of the second group of focus units on the waveguide 3 are outside the orthogonal projection of the out-coupling grating 5 on the waveguide 3. The first group of focus units is configured to receive both the image light L1 and the ambient light L2 to adjust focus positions of both the image light L1 and the ambient light L2, and the second group of focus units is configured to receive the ambient light L2 and exclude the image light L1 to adjust a focus position of the ambient light L2 only. The control module 12 is configured to independently change the diopter of each focus unit 60, so that each focus unit 60 independently adjusts the focus positions of the ambient light L2 and the image light L1.

In one embodiment, the control module 12 changes the diopter of each focus unit 60 by voltage variation. Each focus unit 60 includes a first sub-housing 60a, a first sub-medium 601 contained in the first sub-housing 60a, a second sub-medium 602 contained in the first sub-housing 60a, and a sub-light-transmitting surface 603 between the first sub-medium 601 and the second sub-medium 602. The first sub-medium 601 is on a side of the second sub-medium 602 away from the waveguide 3. Both the first sub-medium 601 and the second sub-medium 602 are liquid and immiscible with each other, such that the sub-light-transmitting surface 603 is formed between the first sub-medium 601 and the second sub-medium 602.

In each focus unit 60, the refractive index of the second sub-medium 602 is greater than the refractive index of the first sub-medium 601. The sub-light-transmitting surface 603 protrudes toward the waveguide 3, so that the shape of the second sub-medium 602 with a larger refractive index is substantially concave lens-shaped, which can diverge light.

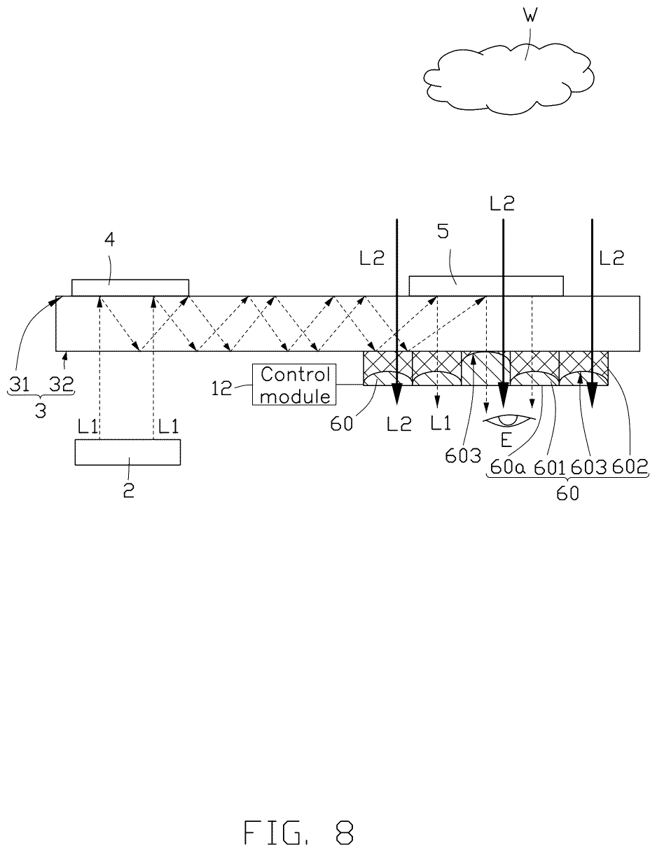

Referring to FIG. 4, FIG. 6, and FIG. 8 together, the control module 12 is electrically connected to each focus unit 60 and utilizes the principle of electrowetting effect to respectively control the curvature of the sub-light-transmitting surface 603 of each focus unit 60 by applying an external voltage, thereby changing the diopter of the first variable focus module 6, and further adjusting the focus positions of the ambient light L2 and the image light L1.

The control module 12 separately controls the curvature of the sub-light-transmitting surface 603 of each focus unit 60 by applying the external voltage, so that the curvatures of the sub-light-transmitting surfaces 603 of at least two focus units 60 are different from each other, thereby changing the diopter of each focus unit 60 to adapt to the needs of users with different refractive issues.

For example, if the user has astigmatism in the left eye and myopia in the right eye, the control module 12 can apply different voltages to the first optical system 11a and the second optical system 11b to individually control the diopter of each focus unit 60, so that the image light L1 and the ambient light L2 received by the user's eyes can be focused on the retina E3 after passing through the first variable focus module 6, the cornea E1, and the crystalline lens E2, thereby enabling users with refractive issues to clearly see virtual scenes and external scenes.

Additionally, when the user is hyperopic but wants to see both virtual scenes and external scenes at different positions simultaneously, the control module 12 controls the curvature of the sub-light-transmitting surface 603 of the focus units 60 within the range of the orthogonal projection of the out-coupling grating 5 on the waveguide 3 by applying an external voltage, that is, controls the focus position of the image light L1 emitted from the out-coupling grating 5, so that the virtual image point formed by the image light L1 moves from infinity toward the human eyes E, thereby enabling the image light L1 to be focused on the focal point Q2 on the retina E3 after passing through the first variable focus module 6, the cornea E1, and the crystalline lens E2, thereby enabling the human eyes E to clearly see the virtual image formed by the image light L1.

After the human eyes E can clearly see the virtual image formed by the image light L1, the control module 12 controls the curvature of the sub-light-transmitting surface 603 of the focus units 60 outside the range of the orthogonal projection of the out-coupling grating 5 on the waveguide 3 by applying an external voltage, that is, controls the focus position of the ambient light L2 incident on the first variable focus module 6 through the waveguide 3, so that the ambient light L2 is focused on the focal point Q1 of the retina E3 after sequentially passing through the user's cornea E1 and the crystalline lens E2, thereby enabling users with refractive issues to clearly see different external scenes, and further enabling users to clearly see both virtual scenes and different external scenes simultaneously.

Furthermore, when the user wants to clearly see distant (or nearby) objects, the control module 12 can further adjust the diopters of the focus units 60 at different positions, so that users with refractive issues can clearly see environmental objects W at different positions, which helps reduce eyestrain for users with refractive issues.

By controlling the diopters of focus units 60 at different positions through the control module 12, the curvatures of the sub-light-transmitting surfaces 603 of focus units 60 at different positions are made different, so that the ambient light L2 is focused on the focal point Q3 of the retina E3 after sequentially passing through the user's cornea E1 and the crystalline lens E2, thereby changing the diopter of each focus unit 60 to match the eyeglass prescription of hyperopic users, enabling users with refractive issues to clearly see both the real environment and the virtual scenes formed by the image light L1 simultaneously, which helps reduce eyestrain for users with refractive issues and improves the user experience.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A near-eye display device, comprising:
a display module configured to emit image light;
a waveguide configured to guide the image light and comprising a first surface and a second surface opposite to the first surface;
an out-coupling grating on the first surface and configured to receive and couple out the image light emitted from the waveguide;
a first variable focus module on the second surface and located on optical paths of the image light and ambient light, the first variable focus module comprising a plurality of focus units connected to each other and arranged in an array extending laterally along the second surface, wherein orthogonal projections of the plurality of focus units on the waveguide cover an orthogonal projection of the out-coupling grating on the waveguide; and
a control module electrically connected to each of the plurality of focus units and configured to independently change a diopter of each of the plurality of focus units, such that each of the plurality of focus units independently adjusts focus positions of the ambient light and the image light.

2. The near-eye display device of claim 1, wherein the plurality of focus units comprises:
a first group of focus units, each having an orthogonal projection on the waveguide overlapping with the orthogonal projection of the out-coupling grating on the waveguide, the first group of focus units configured to receive both the image light and the ambient light; and
a second group of focus units, each having an orthogonal projection on the waveguide non-overlapping with the orthogonal projection of the out-coupling grating on the waveguide, the second group of focus units configured to exclude the image light and receive the ambient light.

3. The near-eye display device of claim 1, wherein each of the plurality of focus units comprises a first sub-medium, a second sub-medium, and a sub-light-transmitting surface between the first sub-medium and the second sub-medium, wherein
the first sub-medium is on a side of the second sub-medium away from the waveguide, and the sub-light-transmitting surface protrudes toward the waveguide; and
the control module is configured to change the diopter of each of the plurality of focus units by controlling a curvature of the sub-light-transmitting surface of each plurality of focus units.

4. The near-eye display device of claim 3, wherein in each of the plurality of focus units, a refractive index of the second sub-medium is greater than a refractive index of the first sub-medium.

5. The near-eye display device of claim 4, wherein curvatures of the sub-light-transmitting surfaces of at least two focus units of the plurality of focus units are different from each other.

6. The near-eye display device of claim 3, wherein the first sub-medium and the second sub-medium are liquid and immiscible with each other.

7. The near-eye display device of claim 1, wherein a shape of each of the orthogonal projections of the plurality of focus units on the waveguide is same.

8. The near-eye display device of claim 7, wherein the shape is selected from a group consisting of hexagonal, circular, triangular, and quadrilateral.

9. The near-eye display device of claim 1, further comprising an in-coupling grating on the first surface and configured to couple the image light into the waveguide.

10. The near-eye display device of claim 1, wherein the control module is further configured to change the diopter of each of the plurality of focus units by changing at least one of spacing variation, polarization switching, refractive index gradation, pressure variation, voltage variation, or piezoelectric variation.

11. A near-eye display device, comprising:
a display module configured to emit image light;
a waveguide comprising a first surface and a second surface opposite to the first surface, the waveguide configured to guide the image light;
an out-coupling grating on the first surface, and configured to receive and couple out the image light emitted from the waveguide;
a first variable focus module on the second surface and located on optical paths of the image light and ambient light;
a second variable focus module on the first surface and located on the optical path of the ambient light; and
a control module configured to independently change a diopter of the first variable focus module to adjust a focus position of the image light, and independently a change diopter of the second variable focus module to adjust a focus position of the ambient light.

12. The near-eye display device of claim 11, wherein the first variable focus module comprises a first medium, a second medium, and a first light-transmitting surface between the first medium and the second medium, wherein
the first medium is on a side of the second medium away from the waveguide, and the first light-transmitting surface protrudes toward the waveguide; and
the control module is electrically connected to the first variable focus module and is further configured to control a curvature of the first light-transmitting surface.

13. The near-eye display device of claim 12, wherein a refractive index of the second medium is greater than a refractive index of the first medium.

14. The near-eye display device of claim 12, wherein the first sub-medium and the second sub-medium are liquid and immiscible with each other.

15. The near-eye display device of claim 11, wherein the second variable focus module comprises a third medium, a fourth medium, and a second light-transmitting surface between the third medium and the fourth medium, wherein
the third medium is on a side of the fourth medium close to the waveguide, and the second light-transmitting surface protrudes away from the waveguide; and
the control module is electrically connected to the second variable focus module and is further configured to control a curvature of the second light-transmitting surface.

16. The near-eye display device of claim 15, wherein a refractive index of the third medium is greater than a refractive index of the fourth medium.

17. The near-eye display device of claim 15, wherein the third sub-medium and the fourth sub-medium are liquid and immiscible with each other.

18. The near-eye display device of claim 11, wherein the control module is further configured to change the diopter of the first variable focus module by changing at least one of spacing variation, polarization switching, refractive index gradation, pressure variation, voltage variation, or piezoelectric variation.

19. The near-eye display device of claim 11, wherein the control module is further configured to change the diopter of the second variable focus module by changing at least one of spacing variation, polarization switching, refractive index gradation, pressure variation, voltage variation, or piezoelectric variation.

20. The near-eye display device of claim 11, further comprising an in-coupling grating on the first surface and configured to couple the image light into the waveguide.
